(19) United States
(12) Patent Application Publication
(10) Pub. No.: US 2022/0277283 A1
(43) Pub. Date: Sep. 1, 2022

(54) SETTLEMENT DEVICE AND PROGRAM

(71) Applicant: TOSHIBA TEC KABUSHIKI KAISHA, Tokyo (JP)

(72) Inventors: Shinsuke Yajima, Mishima Shizuoka (JP); Hidehiro Naito, Mishima Shizuoka (JP); Masaki Ito, Numazu Shizuoka (JP); Yuki Kawaguchi, Tagata Shizuoka (JP); Takahiro Saitou, Izunokuni Shizuoka (JP); Atsushi Miyashima, Izunokuni Shizuoka (JP); Toshihiro Kaneko, Izunokuni Shizuoka (JP); Taiki Tanihira, Izunokuni Shizuoka (JP)

(21) Appl. No.: 17/552,373

(22) Filed: Dec. 16, 2021

(30) Foreign Application Priority Data
Mar. 1, 2021 (JP) 2021-031968

(51) Int. Cl. G06Q 20/20; G06V 10/75; G06V 20/52

(52) U.S. Cl. CPC G06Q 20/208; G06V 10/751; G06V 20/52

(57) ABSTRACT

A settlement device according to an embodiment includes a reading unit configured to read a purchase target commodity, a settling unit configured to perform settlement processing for the commodity for one transaction read by the reading unit, a placing region where an article can be placed, an imaging unit configured to image the placing region, and an informing unit configured to compare, among images acquired by the imaging unit, a first image before the reading of the commodity for the one transaction and a second image at a completion time of the settlement processing and inform if both the images are different.

### CROSS-REFERENCE TO RELATED APPLICATION

This application is based upon and claims the benefit of priority from Japanese Patent Application No. 2021-031968, filed on Mar. 1, 2021, the entire contents of which are incorporated herein by reference.

### FIELD

Embodiments described herein relate generally to a settlement device and a program.

### BACKGROUND

In recent years, in a store such as a supermarket, a self-service checkout device with which a customer performs registration operation and checkout operation for commodities is provided. In such a checkout device, a camera that images a customer operating the checkout device is sometimes provided. There has been proposed a technique for checking, using a captured image, a thing left behind by a customer who used the checkout device.

However, with the checkout device of related art explained above, if a customer left a thing behind, it is possible to check the thing left behind and the customer by viewing a captured image. However, it is difficult to reduce things left behind.

### DESCRIPTION OF THE DRAWINGS

FIG. 1 is a front view illustrating the exterior of a self-service checkout device according to an embodiment;

FIG. 2 is a block diagram illustrating a hardware configuration of the self-service checkout device according to the embodiment;

FIG. 3 is a functional configuration diagram illustrating functions of a settlement device according to the embodiment;

FIG. 4 is a diagram schematically illustrating an example of a state in which an imaging region of a camera of the self-service checkout device according to the embodiment is viewed from above;

FIG. 5 is a diagram schematically illustrating an example of a state in which the imaging region in a rotated state of the camera of the self-service checkout device according to the embodiment is viewed from above; and

FIG. 6 is a flowchart illustrating an example of a flow of imaging processing of the self-service checkout device according to the embodiment.

### DETAILED DESCRIPTION

An aspect of embodiments is to provide, in order to solve the problems described above, a settlement device and a program capable of reducing leaving behind of articles placed on the settlement device.

A settlement device according to an embodiment includes: a reading unit configured to read a purchase target commodity; a settling unit configured to perform settlement processing for the commodity for one transaction read by the reading unit; a placing region where an article can be placed; an imaging unit configured to image the placing region; and an informing unit configured to compare, among images acquired by the imaging unit, a first image before the reading of the commodity for the one transaction and a second image at a completion time of the settlement processing and inform if both the images are different.

A settlement device according to an embodiment is explained in detail below with reference to the accompanying drawings. In this embodiment, an example in which a settlement device of a self-service checkout device for a customer to perform commodity registration and settlement by himself or herself is applied as the settlement device is explained.

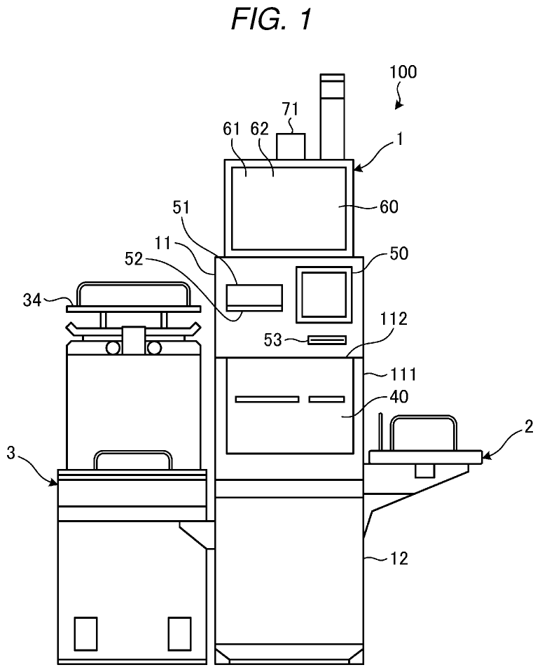

FIG. 1 is a front view illustrating the exterior of a self-service checkout device 100 according to the embodiment. As illustrated in FIG. 1, the self-service checkout device 100 includes a settlement device 1, a basket placing shelf 2, and a bagging shelf 3.

The settlement device 1 includes a first housing 11 and a second housing 12. The first housing 11 includes an openable and closable door 111. The door 111 turns in the up-down direction centering on a hinge section 112. The first housing 11 houses, on the inside, a bill change machine (a bill depositing and dispensing device) and a coin change machine (a coin depositing and dispensing device) configuring a depositing and dispensing unit 40. The second housing 12 houses a control unit 10 on the inside.

The basket placing shelf 2 is an object placing table on which a basket is placed if a motion of taking out a commodity in the basket and holding the commodity over a scanner 50 is performed. The basket placing shelf 2 is provided on one side of the settlement device 1.

The bagging shelf 3 is a table for bagging a commodity after scan. A temporary placement table 34 is provided in the bagging shelf 3. The temporary placement table 34 is a table for temporarily placing a commodity and the like. For example, in order to store a fragile commodity such as eggs or tofu in an upper part of a bag, the commodity is temporarily placed on the temporary placement table 34 without being immediately put in the bag when a symbol of the commodity is read by the scanner 50. The bagging shelf 3 is provided on the other side (the opposite side of the basket placing shelf 2) of the settlement device 1.

The scanner 50 reads the exterior of a purchase target commodity or a sign (a barcode or the like) attached to the commodity in order to specify the commodity. The scanner 50 includes a printer 51 that prints a receipt relating to commodity sales data processing executed by the control unit 10. In the printer 51, a receipt discharge table 52 that supports a discharged receipt is projected from the first housing 11. That is, the receipt discharge table 52 is a convex projecting section provided to project in the first housing 11. A card reader 53 reads a credit card relating to settlement processing executed by the control unit 10.

A monitor 61 is provided on the upper surface of the scanner 50. The monitor 61 displays an image according to control by the control unit 10. A touch panel 62 is provided on the surface of the monitor 61 and outputs information based on a position touched by an operator to the control unit 10.

A camera 71 is an example of an imaging unit. The camera 71 is provided, for example, above the monitor 61. The camera 71 images an article placeable region (hereinafter referred to as placing region as well) provided in the settlement device 1. A region imageable by the camera 71 (hereinafter referred to as imaging region as well) is explained below. The camera 71 only has to be disposed to image the article placeable region provided in the settlement device 1 and may be disposed other than above the monitor 61.

As explained below, the camera 71 may include a turning mechanism capable of changing an imageable region (hereinafter referred to imaging region as well) in the left-right direction (or the up-down direction) in FIG. 1. In this case, an imaging control unit 104 explained below controls the turning mechanism of the camera 71 and turns the camera 71 to change the imaging region of the camera 71.

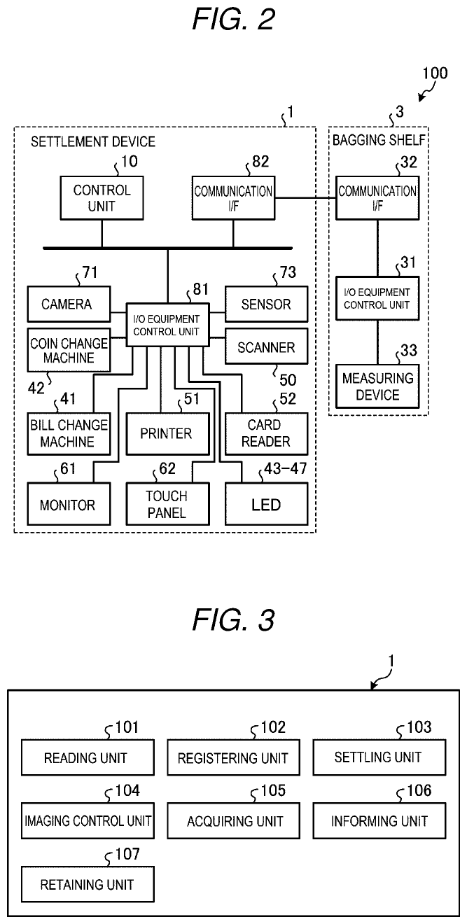

A hardware configuration of the self-service checkout device 100 is explained. FIG. 2 is a block diagram illustrating an example of the hardware configuration of the self-service checkout device 100.

As illustrated in FIG. 2, the settlement device 1 includes the control unit 10, an I/O equipment control unit 81, and a communication I/F (interface) 82. The communication I/F 82 communicably connects the settlement device 1 to the bagging shelf 3. The I/O equipment control unit 81 connects a bill change machine 41, a coin change machine 42, LEDs 43 to 47, the scanner 50, the printer 51, the card reader 53, the monitor 61, the touch panel 62, the camera 71, and a sensor 73 to the control unit 10.

On the other hand, the bagging shelf 3 further includes an I/O equipment control unit 31, a communication I/F (interface) 32, and a measuring device 33. The measuring device 33 measures the weight of an article placed on the bagging shelf 3. The communication I/F 32 communicably connects the bagging shelf 3 to the settlement device 1. That is, the I/O equipment control unit 31 connects the measuring device 33 to the control unit 10 via the communication I/Fs 32 and 82. The measuring device 33 measures the weight on an article on the bagging shelf 3 for the purpose of fraudulent act prevention.

The control unit 10 includes a CPU (Central Processing Unit), a ROM (Read Only Memory), and a RAM (Random Access Memory). The ROM stores various computer programs to be executed by the CPU and various data. The RAM temporarily stores data and a computer program if the CPU executes the computer program.

A functional configuration of the control unit 10 of the settlement device 1 according to the embodiment is explained. FIG. 3 is a block diagram illustrating a functional configuration of the settlement device 1. The CPU operates according to a control program stored in the ROM or the RAM, whereby the control unit 10 functions as a reading unit 101, a registering unit 102, a settling unit 103, an image control unit 104, an acquiring unit 105, an informing unit 106, and a retaining unit 107. The functional components may be realized by hardware. The settlement device 1 only has to include the functions.

The reading unit 101 is an example of a reading unit. The reading unit 101 cooperates with the scanner 50 to perform reading processing for a purchase target commodity. For example, if a customer holds, over the scanner 50, an image in which a commodity code is converted into a sign, the scanner 50 reads the sign and outputs the commodity code. If the scanner 50 outputs the commodity code, the reading unit 101 refers to, for example, a PLU (Price Look Up) file stored in a storing unit of the settlement device 1 or an online-connected external device. The PLU file is a file recording names, prices, and the like of commodities in, for example, a table format in correlation with commodity codes.

The registering unit 102 is an example of a registering unit. The registering unit 102 records, as information concerning the purchase target commodity, information correlated with the commodity code read by the scanner 50 among information stored in the PLU file referred to by the control unit 10 and adds a price of the commodity to a purchase amount.

The settling unit 103 is an example of a settling unit. The settling unit 103 performs settlement processing of a commodity for one transaction read by the reading unit 101. For example, if operation for proceeding to settlement is received from the customer, a price obtained by totaling prices of registered commodities is displayed on the monitor 61. The settling unit 103 starts reception of settlement processing by the customer. In cash settlement, if depositing to the bill change machine and the coin change machine is performed, the settling unit 103 performs processing for calculating a difference (change) from the price. If there is change, the settling unit 103 performs processing for dispensing the change from the bill change machine and the coin change machine.

The imaging control unit 104 is an example of an imaging control unit. The imaging control unit 104 controls the camera 71 to perform processing for imaging the placing region provided in the settlement device 1. Specifically, before reading of a commodity for one transaction is performed, the imaging control unit 104 performs processing for imaging the placing region with the camera 71. If the settlement processing is completed, that is, if the one transaction ends, the imaging control unit 104 performs processing for imaging the placing region with the camera 71.

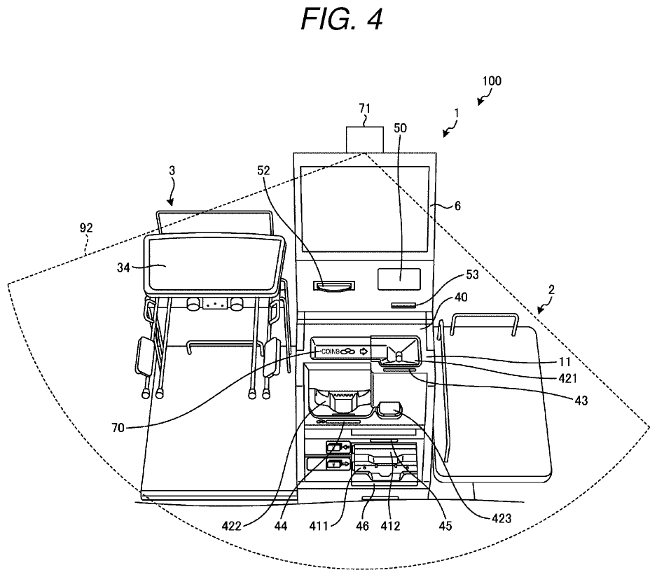

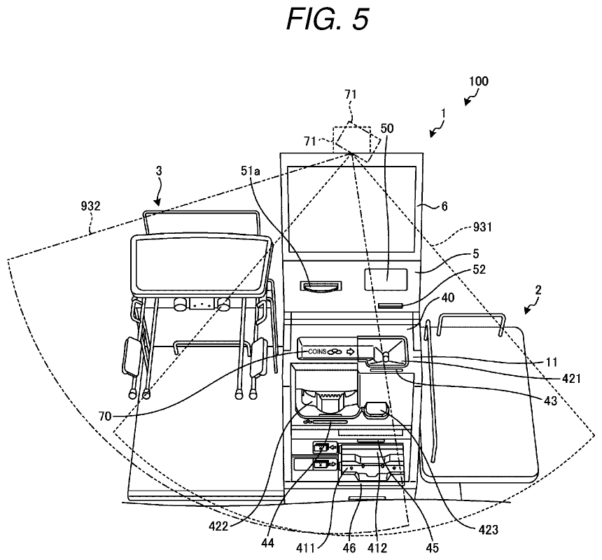

The imaging region of the camera 71 is explained with reference to FIGS. 4 and 5. FIG. 4 is a diagram schematically illustrating an example of a state in which the imaging region of the camera 71 of the self-service checkout device 100 is viewed from above. As illustrated in FIG. 4, in the first housing 11, a depositing port (a coin depositing port) 421 for coins to be deposited to the coin change machine 42 is provided on one end portion side of the upper surface.

In the first housing 11 (the depositing and dispensing unit 40), a coin discharge tray 422 and a reject tray 423 and a bill depositing port 411 and a bill discharge port 412 are provided stepwise in order from the back side where a money placing section 70 and the coin depositing port 421 are provided toward the front side.

The coin discharge tray 422 located in the middle stage is located further on the depth direction front side of the first housing 11 than the money placing section 70 and the coin depositing port 421 located in the upper stage. The bill depositing port 411 and the bill discharge port 412 located in the lower stage are located further on the depth direction front side of the first housing 11 than the coin discharge tray 422 located in the middle stage.

The coin discharge tray 422 is a receiving tray that receives coins discharged from the coin change machine 42. The reject tray 423 is a receiving tray that receives coins that should not be stored in the coin change machine 42 (reject coins) such as deformed coins, foreign coins, and false coins.

As illustrated in FIG. 4, the coin discharge tray 422 is provided on the opposite side end portion of the width direction end portion of the settlement device 1 where the coin depositing port 421 is provided.

The bill depositing port 411 is a depositing port for bills deposited to the bill change machine 41. The bill discharge port 412 is a discharge port for bills discharged from the bill change machine 41.

In addition, the LEDs 43 to 46 for informing an operation procedure and an error are respectively provided near the coin depositing port 421, the coin discharge tray 422, the reject tray 423, the bill depositing port 411, and the bill discharge port 412.

In the configuration explained above, the camera 71 images an imaging region 92. The imaging region 92 is designed in advance to include the entire region of the self-service checkout device 100. Specifically, the imaging region 92 is designed to include the placing region (for example, the temporary placement table 34) provided in the self-service checkout device 100. With such a configuration, the camera 71 is capable of imaging the placing region provided in the self-service checkout device 100.

It is also assumed that a desired region (the temporary placement table 34 or the like) cannot be imaged because, for example, the imaging region of the camera 71 is narrower than the imaging region 92 illustrated in FIG. 4. In such a case, as illustrated in FIG. 5, the camera 71 may be capable of imaging, by being turned, the entire region of the self-service checkout device 100 and the desired region by, for example, including a turning mechanism capable of changing the imaging region in the left-right direction in FIG. 4.

FIG. 5 is a diagram schematically illustrating an example of a state in which the imaging region in a rotated state of the camera 71 of the self-service checkout device 100 according to the embodiment is viewed from above.

In FIG. 5, it is assumed that a default imaging direction of the camera 71 is a front direction of the self-service checkout device 100 and the camera 71 images an imaging region 931 including the customer operating the self-service checkout device 100. The imaging region 931 is narrower than the imaging region 92 explained with reference to FIG. 4 and does not include the temporary placement table 34 in a default state.

In this case, for example, the imaging control unit 104 turns the camera 71 in the left direction in FIG. 5 at a completion time of settlement processing to change the imaging region 931 of the camera 71 to an imaging region 932. Consequently, the imaging control unit 104 can cause the camera 71 to image the temporary placement table 34 on which a thing is highly likely to be left behind according to the completion of the settlement processing.

If a new transaction is started, it is preferable that the imaging control unit 104 returns the imaging region of the camera 71 to the default state (the imaging region 931) to image a motion of a customer performing commodity reading or the like. Consequently, for example, it is also possible to detect a fraudulent act or the like based on the motion of the customer imaged by the camera 71.

Referring back to FIG. 3, the acquiring unit 105 is an example of an acquiring unit. The acquiring unit 105 acquires an image of the placing region captured by the camera 71 before a commodity for one transaction is read, that is, before a transaction (hereinafter referred to as first image) and stores the image in the RAM or the like of the control unit 10. The acquiring unit 105 acquires an image of the placing region captured by the camera 71 at a completion time of settlement processing (hereinafter referred to as second image) and stores the image in the RAM or the like of the control unit 10.

The informing unit 106 is an example of an informing unit. The informing unit 106 determines whether there is a difference between the captured images before and after the transaction captured by the camera 71. Specifically, the informing unit 106 determines whether the first image and the second image acquired by the acquiring unit 105 coincide. The informing unit 106 performs processing for informing if the first image and the second image are different.

Specifically, if the captured images before and after the transaction captured by the camera 71 are different, the informing unit 106 performs processing for informing the settlement device 1 of presence of a thing left behind. For example, after the settlement processing in the settling unit 103, the informing unit 106 outputs sound for informing of the presence of the thing left behind and displays a message such as “something is left behind” on the monitor 61 of the settlement device 1. The informing unit 106 may informing the LEDs 43 to 46 included in the settlement device 1. Consequently, by being informed, the customer can recognize that the customer left a thing behind. It is possible to prevent the customer from leaving behind a wallet, coins, or the like placed in the placing region.

The retaining unit 107 is an example of a retaining unit. The retaining unit 107 retains, based on a determination result of the informing unit 106, the second image acquired by the acquiring unit 105 as a first image of the next transaction. Specifically, if a first image before reading of a commodity for one transaction and a second image at completion time of settlement processing of the transaction coincide, the retaining unit 107 retains the second image as a first image of the next transaction. In this case, the informing unit 106 compares the first image retained by the retaining unit 107 and the second image of the next transaction. The retaining unit 107 may not be used. In this case, the acquiring unit 105 acquires a first image for each transaction.

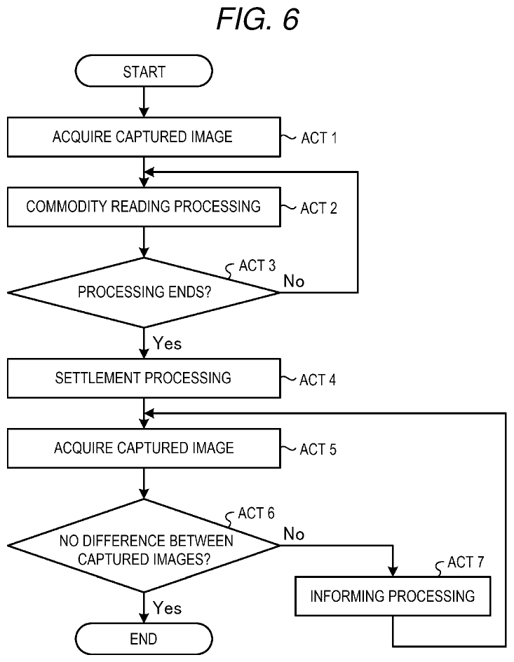

FIG. 6 is a flowchart illustrating an example of processing executed by the self-service checkout device 100 in the embodiment.

First, before a commodity for one transaction is read, the acquiring unit 105 acquires a first image of the placing region captured before the one transaction and stores the first image in the RAM or the like of the control unit 10 (Act 1). If acquisition processing is performed, the processing proceeds to Act 2.

The reading unit 101 cooperates with the scanner 50 to perform reading processing for a purchase target commodity (Act 2). If the reading processing is performed, the processing proceeds to Act 3.

The registering unit 102 registers the purchase target commodity read by the reading unit 101 and determines whether registration processing ends. If the registration processing for the purchase target commodity of the one transaction ends (Yes in Act 3), the processing proceeds to Act 4. If the registration processing for the purchase target commodity of the one transaction is not completed (No in Act 3), the processing proceeds to Act 2.

In Act 4, the settling unit 103 of the control unit 10 performs settlement processing for the commodity for the one transaction read by the reading unit 101 (Act 4). If the settlement processing is performed, the processing proceeds to Act 5.

If the settlement processing is completed, the imaging control unit 104 controls the camera 71 to image the temporary placement table 34, which is the placing region. Subsequently, the acquiring unit 105 acquires a second image of the placing region captured by the camera 71 (Act 5) and stores the second image in the RAM or the like of the control unit 10. Thereafter, the processing proceeds to Act 6.

As explained with reference to FIG. 5, in the case of the configuration in which the camera 71 is capable of turning, the imaging control unit 104 may turn the camera 71 in the direction of the monitoring target placing region (the temporary placement table 34) according to the completion of the settlement processing to cause the camera 71 to image the placing region.

The informing unit 106 compares a first image before reading of the commodity for the one transaction and a second image at a completion time of the settlement processing among captured images acquired by the acquiring unit 105 and determines whether there is no difference between both the images. If there is a difference between the captured images (No in Act 6), the informing unit 106 performs processing for informing (Act 7). Subsequently, the processing is returned to Act 5 to continue the informing until the first image and the second image coincide.

On the other hand, if it is determined in Act 6 that there is no difference between the captured images (Yes in Act 6), the processing is ended.

As explained above, in the settlement device according to this embodiment, the reading unit reads a purchase target commodity. The settling unit performs settlement processing for a commodity for one transaction read by the reding unit. The imaging unit images the placing region where an article can be placed. Further, the informing unit compares a first image before the reading of the commodity for the one transaction and a second image at a completion time of the settlement processing among images acquired by the imaging unit and informs if both the images are different.

Consequently, if the customer leaves something behind, the settlement device is informed that an article is left behind. Since the customer notices the presence of the article left behind from the informing, it is possible to reduce leaving behind of articles placed on the settlement device.

It is also possible to modify and implement the embodiment explained above as appropriate by changing a part of the components or the functions of the device explained above. Therefore, in the following explanation, several modifications relating to the embodiment explained above are explained as other embodiments. In the following explanation, differences from the embodiment explained above are mainly explained. Detailed explanation is omitted about similarities to the content explained above. The modifications explained below may be individually implemented or may be combined and implemented as appropriate.

### (Modification 1)

For example, if a customer enters the imaging region of the camera 71, the imaging control unit 104 may detect that the customer is present in front of the self-service checkout device 100 and perform, at timing of the detection, processing for imaging the placing region of the settlement device 1 using the camera 71. The acquiring unit 105 may acquire a first image as a first captured image, which is a captured image before a transaction.

### (Modification 2)

For example, the acquiring unit 105 may acquire a first captured image before reading of a commodity for one transaction as an image serving as a reference stored in the ROM or the like of the control unit 10 in advance. By acquiring the first captured image serving as the reference, processing of the imaging control unit 104 is reduced. Resources of the CPU of the control unit 10 can be reduced.

### (Modification 3)

For example, if captured images before and after a transaction captured by the camera 71 are different, the informing unit 106 may inform an external device of presence of a thing left behind. The external device is, for example, an attendant terminal used by a store clerk in a store or an external server that stores, for example, information concerning a thing left behind. By informing the external device of the presence of the thing left behind, even if a store clerk is absent near the self-service checkout device 100, the store clerk can grasp the information concerning the thing left behind. The store clear can quickly inform a customer leaving the thing behind about measures for the thing left behind. Therefore, leaving behind of articles placed on the settlement device is reduced.

### (Modification 4)

In the embodiment, the temporary placement table 34 is the placing region. However, the placing region is not limited to this and may be other parts. For example, the placing region may be the money placing section 70, the bill discharge port 412, the coin discharge tray 422, the reject tray 423, and the like of the first housing 11 illustrated in FIG. 4 (FIG. 5). If a plurality of placing regions are monitored, the informing unit 106 only has to compare states of the placing regions before and after a transaction. Consequently, the same effects as the effects of the embodiment explained above can be achieved. Therefore, it is possible to reduce leaving behind of articles placed on the money placing section 70, the bill discharge port 412, the coin discharge tray 422, the reject tray 423, and the like besides the temporary placement table 34.

A computer program to be executed by the self-service checkout device 100 in this embodiment is provided while being recorded in a computer-readable recording medium such as a CD-ROM, a flexible disk (FD), a CD-R, or a DVD (Digital Versatile Disk) as a file of an installable format or an executable format.

The computer program to be executed by the self-service checkout device 100 in this embodiment may be stored on a computer connected to a network such as the Internet and provided by being downloaded through the network. The computer program to be executed by the self-service checkout device 100 in this embodiment may be provided or distributed through the network such as the Internet.

The computer program to be executed by the self-service checkout device 100 in this embodiment may be incorporated in the ROM or the like in advance and provided.

Several embodiments are explained above. However, the embodiments are presented as examples and are not intended to limit the scope of the invention. These new embodiments can be implemented in other various forms. Various omissions, substitutions, and changes can be made without departing from the spirit of the invention. These embodiments and modifications of the embodiments are included in the scope and the gist of the invention and included in the inventions described in claims and the scope of equivalents of the inventions.

What is claimed is:

1. A settlement device, comprising:
a reading component configured to read a purchase target commodity;
a settling component configured to perform settlement processing for the commodity for one transaction read by the reading component;
a placing region configured to receive an article;
an imaging component configured to image the placing region; and
an informing component configured to compare, among images acquired by the imaging component, a first image before the reading of the commodity for the one transaction and a second image at a completion time of the settlement processing and inform if both the images are different from each other.

2. The settlement device according to claim 1, further comprising an imaging controller configured to change an imaging region of the imaging component at the completion time of the settlement processing to cause the imaging component to image the placing region.

3. The settlement device according to claim 1, wherein the informing component performs the comparison with the second image using the first image stored in advance.

4. The settlement device according to claim 1, further comprising a retaining component configured to, if the first image before the reading of the commodity for the one transaction and the second image at the completion time of the settlement processing coincide, retain a captured image captured after the transaction as the first image of a next transaction, wherein
the informing component compares the first image retained by the retaining component and the second image of the next transaction.

5. The settlement device according to claim 1, wherein the placing region is a temporary placement table for temporarily placing the commodity after reading by the reading component.

6. The settlement device according to claim 1, wherein the reading component comprises a scanner.

7. The settlement device according to claim 1, further comprising:
a measuring device configured to measure a weight of the purchase target commodity for fraudulent act prevention.

8. A settlement method for a settlement device, comprising:
reading a purchase target commodity;
performing settlement processing of the read commodity for one transaction;
imaging a placing region where an article is placed; and
comparing, among acquired images, a first image before the reading of the commodity for the one transaction and a second image at a completion time of the settlement processing and informing if both the images are different from each other.

9. The settlement method according to claim 8, further comprising:
changing an imaging region at the completion time of the settlement processing to cause imaging of the placing region.

10. The settlement method according to claim 8, further comprising:
comparing with the second image using the first image stored in advance.

11. The settlement method according to claim 8, further comprising:
if the first image before the reading of the commodity for the one transaction and the second image at the completion time of the settlement processing coincide, retaining a captured image captured after the transaction as the first image of a next transaction; and
comparing the first image retained by the retaining component and the second image of the next transaction.

12. The settlement method according to claim 8, wherein the placing region is a temporary placement table for temporarily placing the commodity after reading by the reading component.

13. The settlement method according to claim 8, further comprising:
measuring a weight of the purchase target commodity for fraudulent act prevention.

14. A self-service checkout device, comprising:
a reading component that reads a purchase target commodity;
a settling component configured to perform settlement processing for the commodity for one transaction read by the reading component;
a placing region configured to receive an article;
an imaging component that images the placing region; and
an informing component that compares, among images acquired by the imaging component, a first image before the reading of the commodity for the one transaction and a second image at a completion time of the settlement processing and inform if both the images are different from each other.

15. The self-service checkout device according to claim 14, further comprising an imaging controller that changes an imaging region of the imaging component at the completion time of the settlement processing to cause the imaging component to image the placing region.

16. The self-service checkout device according to claim 14, wherein the informing component performs the comparison with the second image using the first image stored in advance.

17. The self-service checkout device according to claim 14, further comprising a retaining component configured to, if the first image before the reading of the commodity for the one transaction and the second image at the completion time of the settlement processing coincide, retain a captured image captured after the transaction as the first image of a next transaction, wherein
the informing component compares the first image retained by the retaining component and the second image of the next transaction.

18. The self-service checkout device according to claim 14, wherein the placing region is a temporary placement table for temporarily placing the commodity after reading by the reading component.

19. The self-service checkout device according to claim 14, wherein the reading component comprises a scanner.

20. The self-service checkout device according to claim 14, further comprising:
a measuring device configured to measure a weight of the purchase target commodity for fraudulent act prevention.
